(19) United States
(12) Patent Application Publication
(10) Pub. No.: US 2018/0354298 A1
(43) Pub. Date: Dec. 13, 2018

(54) WHEEL ASSEMBLY

(71) Applicant: Orbis Wheels, Inc., Mill Valley, CA (US)

(72) Inventors: Marcus G. Hays, San Rafael, CA (US); Scott Streeter, Santa Rosa, CA (US)

(21) Appl. No.: 16/006,088

(22) Filed: Jun. 12, 2018

Related U.S. Application Data
(60) Provisional application No. 62/655,068, filed on Apr. 9, 2018.
(60) Provisional application No. 62/518,096, filed on Jun. 12, 2017.

(51) Int. Cl. B60B 21/02; B60K 7/00; B60B 27/00; B60B 21/08

(52) U.S. Cl. CPC B60B 21/028; B60K 7/0007; B60B 27/0063; B60B 21/08; B60B 27/0026

(57) ABSTRACT

A wheel may include a centerless rim with a rail with a driving feature, where the rail protrudes towards a middle of the centerless rim in a first plane. The wheel may also include a stationary hub positioned along a second plane generally parallel with the first plane. The wheel may additionally include a roller guide assembly that includes a support member coupled to the stationary hub and configured to bridge the rail, and first and second roller guides coupled to the support member and positioned to roll along the centerless rim adjacent to and on either side of the rail. The wheel may additionally include a spring positioned to bias the first roller guide against the centerless rim.

### CROSS-REFERENCE TO RELATED APPLICATION

This application claims priority to U.S. Application No. 62/518,096 filed on Jun. 12, 2017, and U.S. Application No. 62/655,068 filed on Apr. 9, 2018, both of which are incorporated herein by reference in their entireties.

### FIELD

The embodiments discussed in the present disclosure relate to a wheel assembly.

The subject matter claimed in the present disclosure is not limited to embodiments that solve any disadvantages or that operate only in environments such as those described above. Rather, this statement is only provided to illustrate one example technology area where some embodiments described may be practiced.

### SUMMARY

In one or more embodiments of the present disclosure, the present disclosure may include a wheel that includes a centerless rim that includes a rail with a driving feature, where the rail protrudes towards a middle of the centerless rim in a first plane. The wheel may also include a stationary hub positioned along a second plane generally parallel with the first plane. The wheel may additionally include a first roller guide assembly, where the first roller guide assembly includes a first support member coupled to the stationary hub and configured to bridge the rail, a first roller guide coupled to the first support member and positioned to roll along the centerless rim adjacent the rail, and a second roller guide coupled to the first support member and positioned to roll along the centerless rim adjacent the rail. The wheel may also include a second roller guide assembly that includes a second support member coupled to the stationary hub and configured to bridge the rail, a third roller guide coupled to the second support member and positioned to roll along the centerless rim adjacent the rail, and a fourth roller guide coupled to the second support member and positioned to roll along the centerless rim adjacent the rail. The wheel may additionally include a third roller guide assembly with a fifth roller guide configured to roll along the centerless rim adjacent the rail, and a spring positioned to bias the fifth roller guide against the centerless rim.

The object and advantages of the present disclosure will be realized and achieved at least by the elements, features, and combinations particularly pointed out in the claims.

It is to be understood that both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example wheel assembly;

FIG. 2 illustrates another example of wheel assembly components;

FIG. 3 illustrates an example stationary hub;

FIG. 4 illustrates an example component to facilitate support of a drive shaft;

FIG. 5 illustrates an example disk for mounting a motor;

FIG. 6 illustrates an example support member of a roller guide assembly;

FIG. 7 illustrates another example of a support member of a roller guide assembly;

FIG. 8 illustrates another example of a support member of a roller guide assembly;

FIG. 9A illustrates an example roller guide of a roller guide assembly;

FIG. 9B illustrates an example roller spacer of a roller guide assembly;

FIG. 9C illustrates an example bracket of a roller guide assembly;

FIGS. 10A-10C illustrate various view of an example of a roller guide assembly with a spring;

FIG. 11 illustrates another example roller guide assembly;

FIGS. 12A and 12B illustrate various view of an example centerless rim;

FIG. 13 illustrates an example brake rotor for coupling to a centerless rim;

FIGS. 14A and 14B illustrate an example of attaching an example wheel assembly to an example wheel arm;

FIGS. 15A-15B illustrate an automobile with a wheel assembly coupled to a wheel arm;

FIGS. 16A-16D illustrate various views of another example wheel assembly;

FIG. 17 illustrates another view of the example wheel assembly of FIGS. 16A-16D; and

FIG. 18 illustrates another view of an example wheel assembly.

### DESCRIPTION OF EMBODIMENTS

Embodiments of the present disclosure are explained with reference to the accompanying drawings.

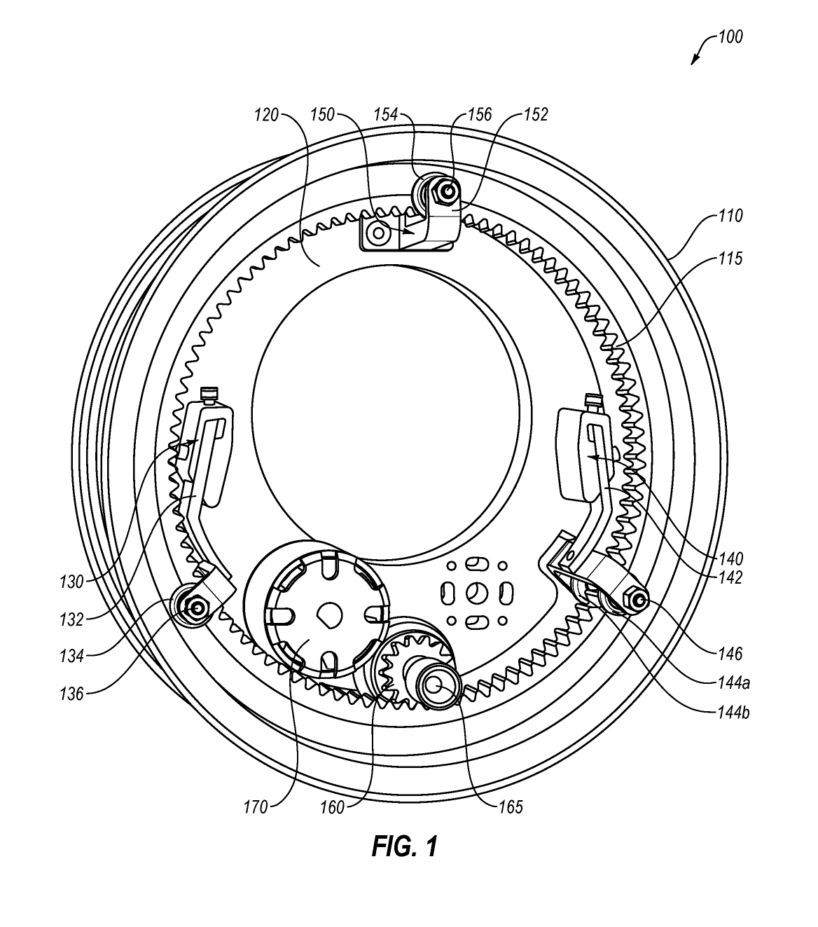

FIG. 1 illustrates an example wheel assembly 100, in accordance with one or more embodiments of the present disclosure. The wheel assembly 100 may include a centerless rim 110, a stationary hub 120, a first roller guide assembly 130, a second roller guide assembly 140, a third roller guide assembly 150, a driving gear 160, and a motor 170.

The centerless rim 110 may include any shape or profile. The centerless rim 110 may include a profile such that one or more roller guides (such as roller guides of the first roller guide assembly 130, the second roller guide assembly 140, or the third roller guide assembly 150) may roll along the centerless rim 110. The centerless rim 110 may include a tire (not illustrated) coupled to an outside of the centerless rim. The centerless rim 110 may be sized to be comparable or similar in size to an automobile or motorcycle wheel. For example, the centerless rim 110 may be sized of a circumference and/or width comparable or similar to any standardized size of wheel used on automobiles, motorcycles, scooters, earth-moving equipment, wheelchairs and mobility devices, lawn and garden machines, planetary rovers, race cars (e.g., formula one cars, stock cars, etc.), and/or any other vehicle in general. In some embodiments, the centerless rim 110 may enclose a generally cylindrical shape with two flat faces and one curved face. The centerless rim 110 may be configured to rotate about a line that passes perpendicularly through the two flat faces.

In some embodiments, the centerless rim 110 may include a rail 115. The rail 115 may be configured to project inward towards the middle of the centerless rim 110. The rail 115 may be positioned along a plane that is generally parallel with the flat faces of the cylindrical shape enclosed by the centerless rim 110. The rail may include a driving feature, such as a toothed gear for driving the centerless rim 110.

The stationary hub 120 may include any component or device configured to support one or more components of the wheel assembly 100 that may remain fixed relative to the rotation of the centerless rim 110. For example, the centerless rim 110 may be driven to rotate along the line that passes perpendicularly through the two flat faces. Relative to such rotation, the stationary hub 120 may remain in a fixed orientation. In some embodiments the stationary hub 120 may support a brake caliper (not illustrated).

In some embodiments, the stationary hub 120 may be coupled to the first, second, and/or third roller guide assemblies 130, 140, and 150, respectively. In some embodiments, the first, second, and/or third roller guide assemblies 130, 140, and 150, respectively, may function cooperatively to maintain the stationary hub 120 in the stationary position relative to the centerless rim 110.

The first roller guide assembly 130 may include a first support member 132, a first roller guide 134 and a second roller guide (not illustrated), and a first axle shaft 136 and a second axle shaft (not illustrated). The first support member 132 may be configured to be fixedly coupled to the stationary hub 120 and bridge the rail 115 of the centerless rim 110. For example, the first support member 132 may include a mounting component coupled to the stationary hub with an arm extending from the mounting component, and a bracket at the end of the arm that spans the rail 115. The bracket may support the first axle shaft 136 and the second axle shaft in a cantilevered manner such that the rail 115 may pass freely between the first roller guide 134 and the second roller guide. The first roller guide 134 may rotate around the first axle shaft 136 and the second roller guide may rotate around the second axle shaft.

In some embodiments, the axle shafts (e.g., the first axle shaft 136) may be shaped to support both the first roller guide 134 and the second roller guide. For example, the first axle shaft 136 may be bent or otherwise shaped to support the first roller guide 134 on a first side of the rail 115 and a second roller guide on a second side of the rail 115 opposite the first side.

In some embodiments, by utilizing the first support member 132 that bridges the rail 115, a moment of inertia for the roller guides may be reduced. For example, a small radius roller guide may be used when compared to other wheel assemblies. For example, the radius of the first roller guide 134 may be smaller than the height of the rail 115. As another example, a small radius axle shaft may be utilized. In these and other embodiments, by using the small radius roller guide and small radius axle shaft, the moment of inertia for the roller guide may be lowered. By lowering the moment of inertia for the first roller guide assembly 130, the moment of inertia for the entire wheel assembly 100 may be reduced. In some embodiments, the radius of the first axle shaft 136 may be sized to facilitate a reduced moment of inertia. In some embodiments, the radius of the first roller guide 134 may be less than approximately 0.75 inches, less than approximately 0.5 inches, or less than approximately 0.4 inches. Additionally or alternatively, the radius of the first axle shaft 136 may be less than 0.5 inches, less than 0.3 inches, or less than 0.2 inches. Additionally, any size roller guide may be utilized, and the size may be selected based on a size of the wheel assembly 100, the application in which the wheel assembly 100 is being used, and/or other considerations. Additionally, by utilizing a small radius roller guide and/or axle shaft for the second roller guide assembly 140 and third roller guide assembly 150, the moment of inertia for the wheel assembly 100 may be further reduced.

In some embodiments, the reduced moment of inertia may provide efficiencies in operating the wheel assembly 100 as compared to a traditional wheel, or other wheel configurations. For example, the reduced moment of inertia may make it easier for the wheel assembly 100 to start and/or continue rolling.

The second roller guide assembly 140 may be similar or comparable to the first roller guide assembly 130. For example, the second roller guide assembly 140 may include a second support member 142 similar or comparable to the first support member 132, a third roller guide 144a similar or comparable to the first roller guide 134, a third axle shaft 146 similar or comparable to the first axle shaft 136, and a fourth roller guide 144b that rotates around a fourth axle shaft (not illustrated) that are similar or comparable to the second roller guide and second axle shaft. The second support member 142 may be coupled to the stationary hub 120 and may bridge the rail 115.

In some embodiments the first roller guide assembly 130 may be positioned such that the first roller guide 134 and the second roller guide contact the centerless rim 110 at approximately an eight o'clock position, and the second roller guide assembly 140 may be positioned such that the third roller guide 144a and the fourth roller guide 144b contact the centerless rim 110 at approximately a four o'clock position. The location of where the roller guides contact the centerless rim 110 may be how the location of a roller guide assembly may be described. For example, a roller guide assembly at a four o'clock position may indicate that the roller guides of the roller guide assembly may contact the centerless rim 110 at a four o'clock position. In some embodiments, the first roller guide assembly 130 and the second roller guide assembly 140 may be positioned symmetrical about the centerless rim 110 (e.g., such that the first roller guide assembly 130 and the second roller guide assembly 140 are approximately the same distance from the driving gear 160. The first roller guide assembly 130 may be positioned anywhere between a ten o'clock position and a seven o'clock position, and the second roller guide assembly 140 may be positioned anywhere between a two o'clock and a five o'clock position. The various positions with reference to a time of day may include the location of numerals in an analog clock face that corresponds to the wheel assembly 100. In some embodiments, the first roller guide assembly 130, second roller guide assembly 140, and third roller guide assembly 150 may be approximately equally spaced around the circumference of the wheel assembly 100. In some embodiments, such spacing may occur around one of the roller guides at a target position, such as at the top of the wheel assembly 100 (e.g., a twelve o'clock position), at a three o'clock position, a six o'clock position, or a nine o'clock position.

The third roller guide assembly 150 may be positioned at approximately a twelve o'clock position. The third roller guide assembly 150 may include a third support member 152 that may be similar or comparable to the first support member 132, a fifth roller guide 154 that may be similar or comparable to the first roller guide 134 and a fifth axle shaft 156 that may be similar or comparable to the first axle shaft 136, and a sixth roller guide and sixth axle shaft that may be similar or comparable to the second roller guide and second axle shaft.

In some embodiments, the third support member 152 may include a different shape or geometry to facilitate the fifth 154 and sixth roller guides contacting the centerless rim 110 at approximately the twelve o'clock position. For example, the third support member 152 may include a mounting component and a bracket as a single unitary body.

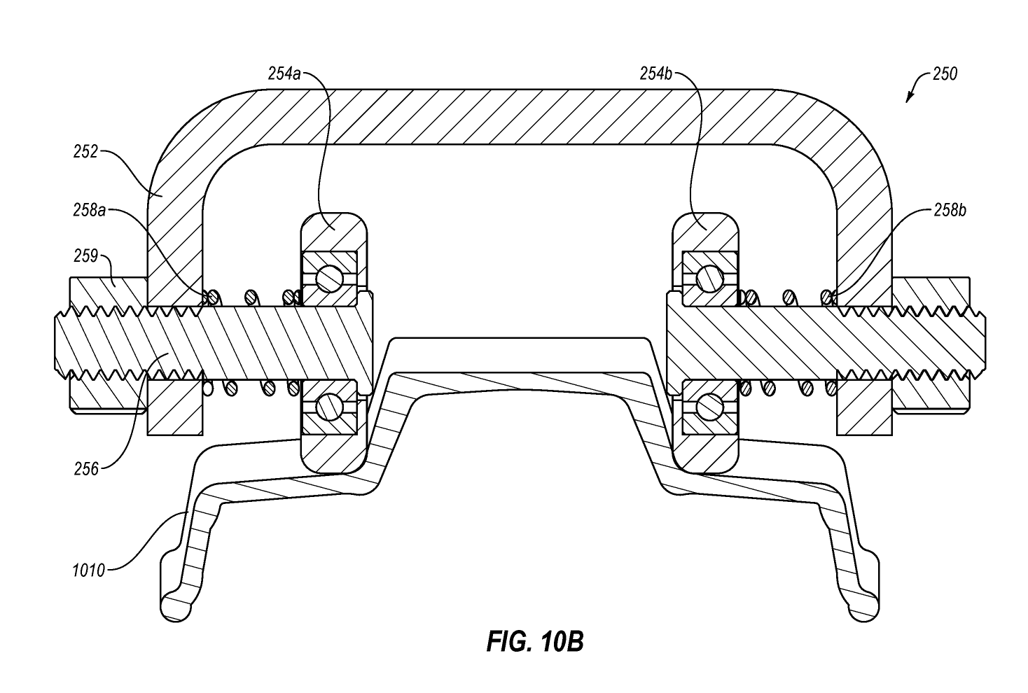

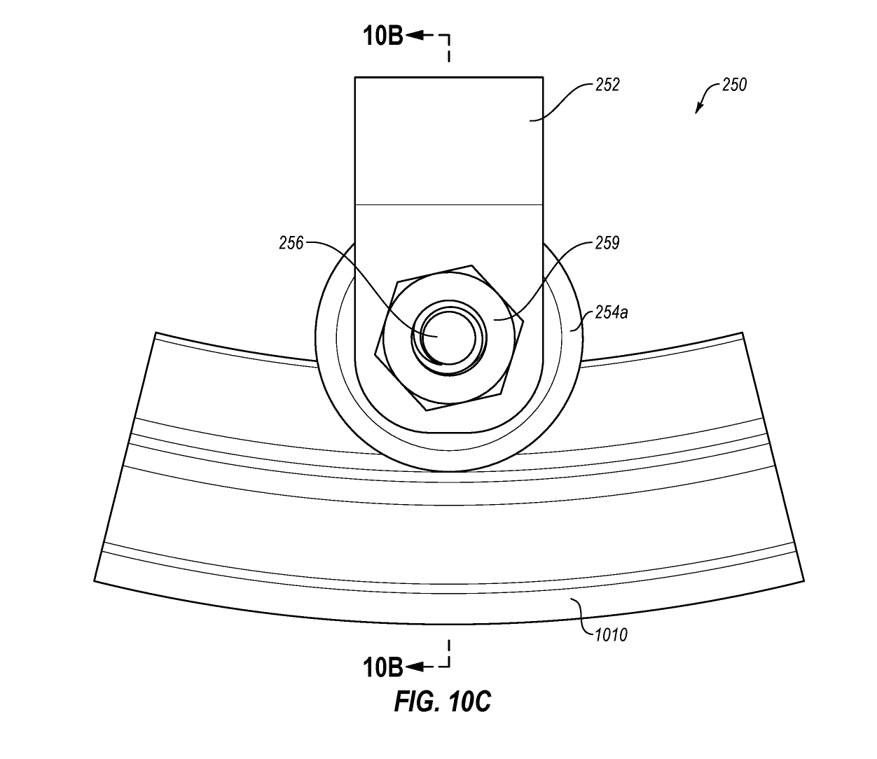

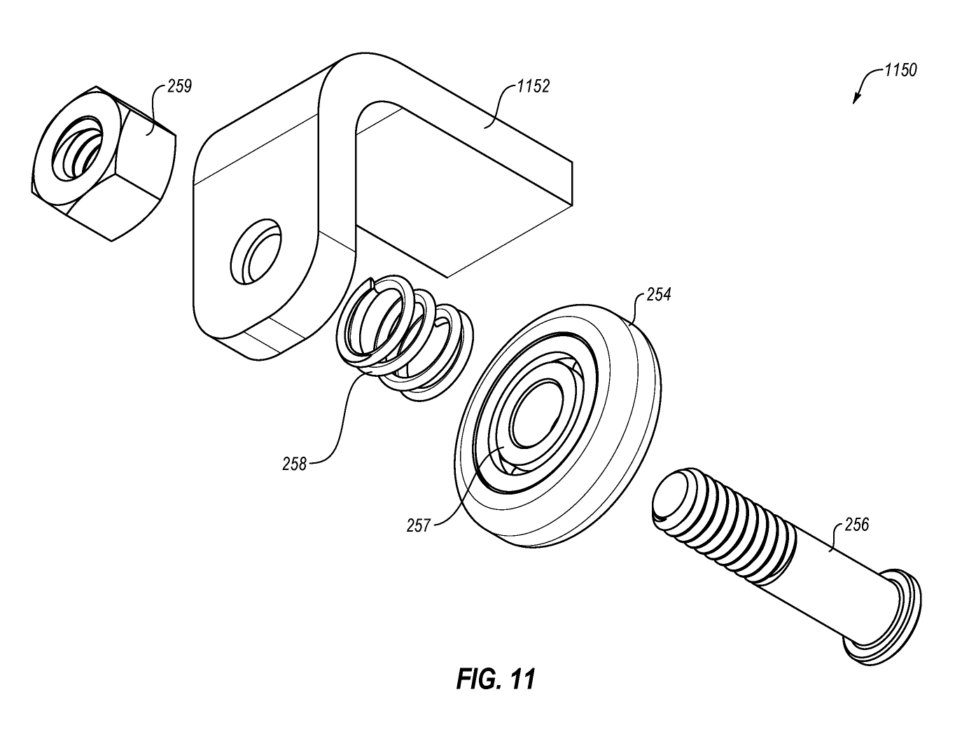

In some embodiments, the third roller guide assembly 150 may include a spring disposed between the third support member 152 and the fifth roller guide 154 to bias the fifth roller guide 154 against the centerless rim 110. For example, the centerless rim 110 may include a curvature, slant, or incline from an edge of the centerless rim 110 to the rail 115. As extraordinary forces (e.g., cornering, hitting a pothole, going airborne, etc.) are experienced, the spring may bias the fifth roller guide 154 to maintain contact with the centerless rim 110. Additionally or alternatively, as the fifth roller guide 154 experiences wear, the spring may push the fifth roller guide 154 further along the incline such that even though the fifth roller guide 154 may be shorter due to wear, it still contacts the centerless rim 110. Examples of such an embodiment may be illustrated in greater detail with reference to FIGS. 10A-C and/or FIG. 11.

The driving gear 160 may include any component or feature configured to interface with the drive component of the centerless rim 110. For example, for friction-based drive systems, the driving gear 160 may include an additional roller guide or other feature configured to roll along the centerless rim 110. For gear-based drive systems (e.g., as illustrated in FIG. 1), the driving gear 160 may include a toothed gear that interfaces with the driving component of the centerless rim 110 such that as the driving gear 160 rotates, the centerless rim 110 rotates. Although illustrated as using a toothed gear, other drive components are also contemplated for providing torque to the centerless rim 110. For example, a pulley, a friction-based system, sprockets and chain, etc. may be used to impart torque to rotate the centerless rim 110.

In some embodiments, the driving gear may be coupled to a drive shaft 165. The drive shaft 165 may include a belt receiving portion, a chain receiving portion, a transmission portion, or some other feature for interfacing with the motor 170 such that the motive force generated by the motor 170 may cause the drive shaft 165 to rotate. In some embodiments the rotation of the drive shaft may be passed to the drive gear 160, for example, by keying the drive shaft 165 and the drive gear 160, or any other known mechanism for causing two bodies (the drive gear 160 and the drive shaft 165) to rotate as a single body.

In some embodiments, there may be bearings, including one way bearings, between the drive shaft 165 and the drive gear 160. The bearings may facilitate rotation of the drive gear 160 relative to the drive shaft 165. Additionally or alternatively, the bearings may facilitate driving the drive gear 160 in one direction of rotation of the drive shaft 165 while allowing the drive gear 160 to rotate freely about the drive shaft 165 in the other direction. In some embodiments, the drive shaft 165 may pass through the stationary hub 120 such that the drive shaft 165 and/or the drive gear 160 may rotate about the drive shaft 165 while the stationary hub 120 remains in place.

In some embodiments, the motor 170 may include any source of motive power. For example, the motor 170 may include an electric motor such as a direct current (DC) motor, an alternating current (AC) motor, a brush motor, a brushless motor, a shunt wound motor, a separately excited motor, a series wound motor, a compound wound motor, a permanent magnet motor, a servomotor, an induction motor, a synchronous motor, a linear induction motor, a synchronous linear motor, etc. As another example, the motor 170 may include a fuel consuming engine, such as a four stroke engine, a diesel engine, a two stroke engine, a Wankel engine, an Atkinson engine, a gnome rotary engine, etc. In some embodiments, the motor 170 may include a small, high-speed, high-efficiency DC electric motor that may rotate at speeds greater than six thousand rotations per minute (RPM). In these and other embodiments, the use of such a small motor may be available because of the reduced moment of inertia as described herein.

Modifications, additions, or omissions may be made to FIG. 1 without departing from the scope of the present disclosure. For example, the centerless wheel assembly 100 may include more or fewer elements than those illustrated and described in the present disclosure. For example, the wheel assembly 100 may include any of the components or arrangements consistent with the present disclosure. As another example, the wheel assembly 100 may include one or more exoskeleton plates and one or more roller guides (not illustrated).

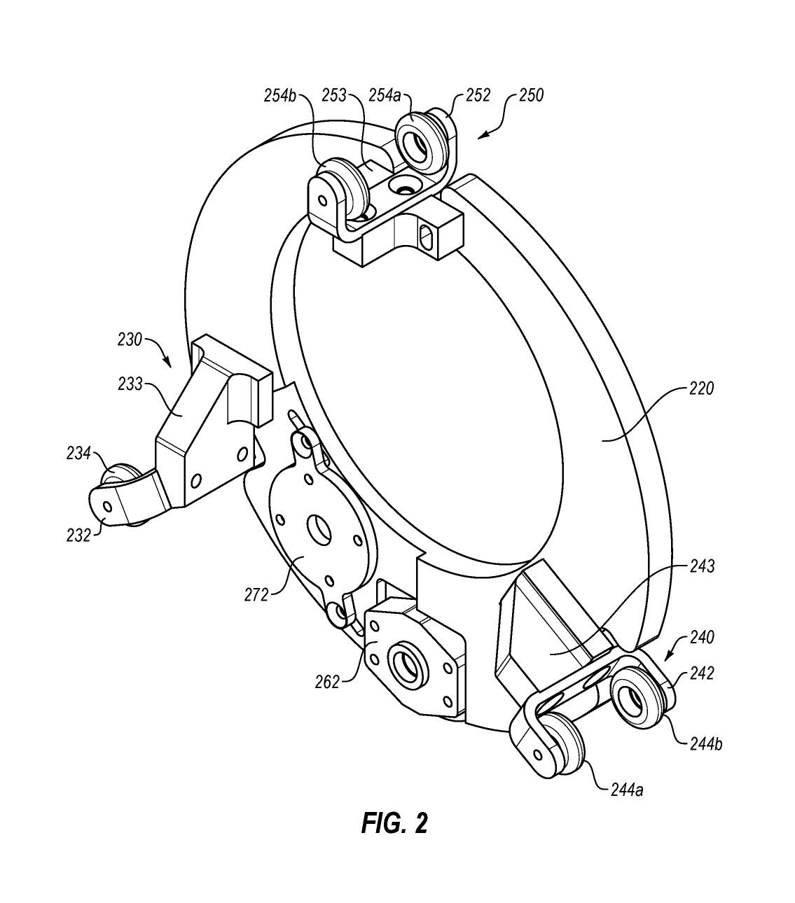

FIG. 2 illustrates another example of wheel assembly components, in accordance with one or more embodiments of the present disclosure. For example, FIG. 2 may illustrate a stationary hub 220, three roller guide assemblies 230, 240, and 250, one or more components 262 to support the drive shaft/drive gear, and/or a disk 272 to support the motor. One or more of the components may be similar or comparable to the commonly named components of FIG. 1. For example, the stationary hub 120 of FIG. 1 may be similar or comparable to the stationary hub 220 of FIG. 2, and the roller guide assemblies 130, 140, and 150 of FIG. 1 may be similar or comparable to the roller guide assemblies 230, 240, and 250 of FIG. 2.

As illustrated in FIG. 2, the roller guide assemblies 230, 240, and 250 may include a different structure than the roller guide assemblies of FIG. 1. For example, support members 233, 243, and 253 of FIG. 2 may include a solid unitary body rather than an arm coupled to a mounting component.

The roller guide assembly 230 may include a bracket 232, the support member 233, and the roller guide 234. The roller guide assembly 240 may include a bracket 242, the support member 243, and the roller guides 244a and 244b. The roller guide assembly 250 may include a bracket 252, the support member 253, and the roller guides 254a and 254b. While not illustrated, the components of FIG. 2 may interface with a centerless rim as illustrated in FIG. 1.

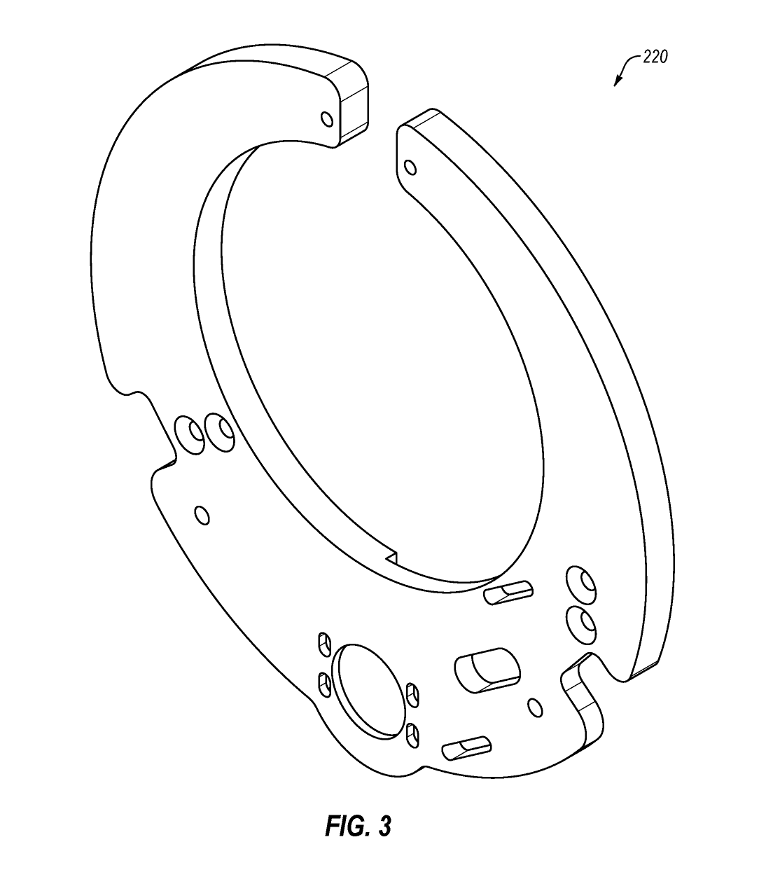

FIGS. 3-8 and 9A-9C provide more detailed views of various aspects of the wheel assembly components of FIG. 2.

FIG. 3 illustrates an example stationary hub 220, in accordance with one or more embodiments of the present disclosure.

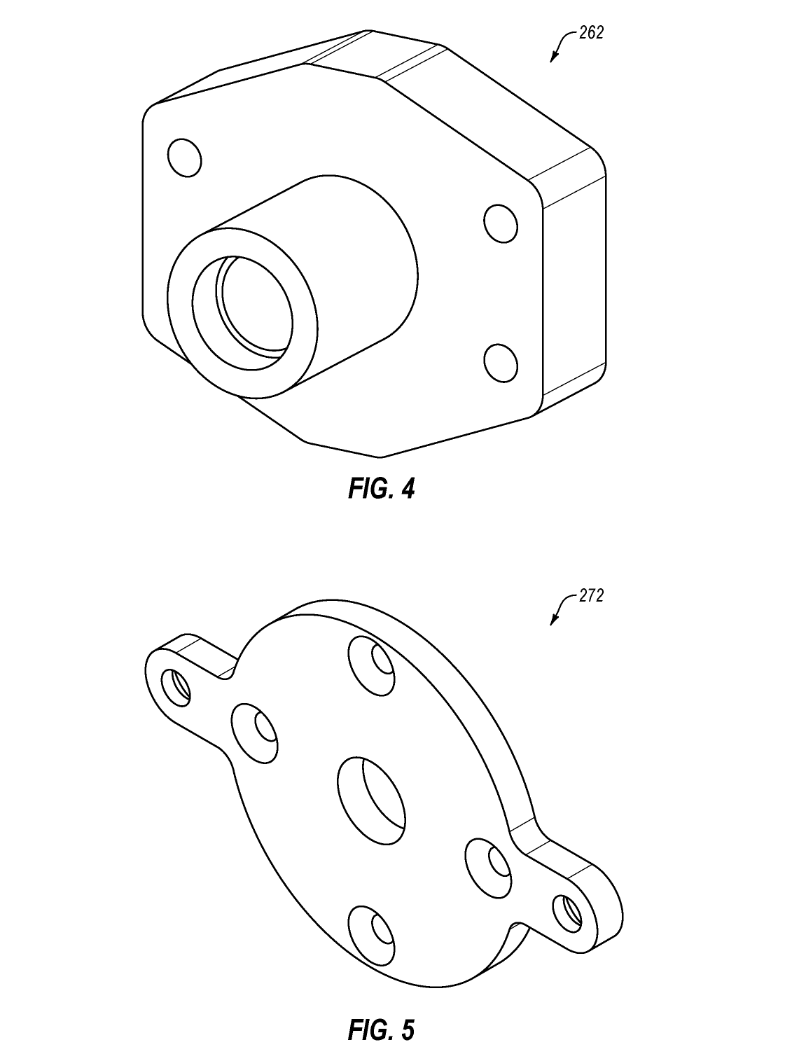

FIG. 4 illustrates an example component 262 to facilitate support of the drive shaft, in accordance with one or more embodiments of the present disclosure. For example, the component 262 of FIG. 4 may span one side of the stationary hub 220 to the other while supporting the drive shaft. Additionally or alternatively, the component 262 of FIG. 4 may be configured to facilitate free rotation of the drive shaft within the channel of the component 262. In these or other embodiments, the channel may include bearings, rollers, lubrication, etc.

FIG. 5 illustrates an example disk 272 for mounting a motor, in accordance with one or more embodiments of the present disclosure. For example, the disk of FIG. 5 may be bolted or otherwise coupled to the stationary hub 220 of FIG. 2. Additionally or alternatively, the disk 272 may include holes or other features for coupling a motor to the disk 272. The disk 272 may include any of a variety of holes or features or may be any size or shape to couple with any style or type of motor. In some embodiments, the motor may be mounted elsewhere (e.g., to an automobile or motorcycle) than on the wheel (such as the wheel assembly 100 of FIG. 1). In these and other embodiments, the motor may be coupled to a component that remains stationary relative to the rotating centerless rim (such as the centerless rim 110 of FIG. 1).

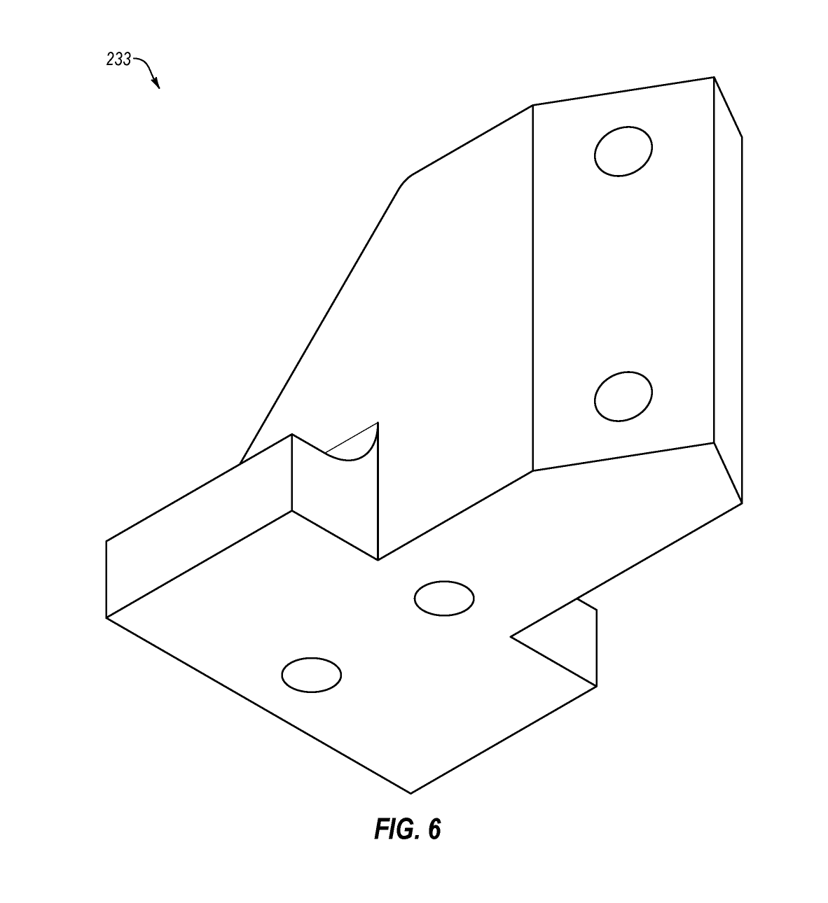

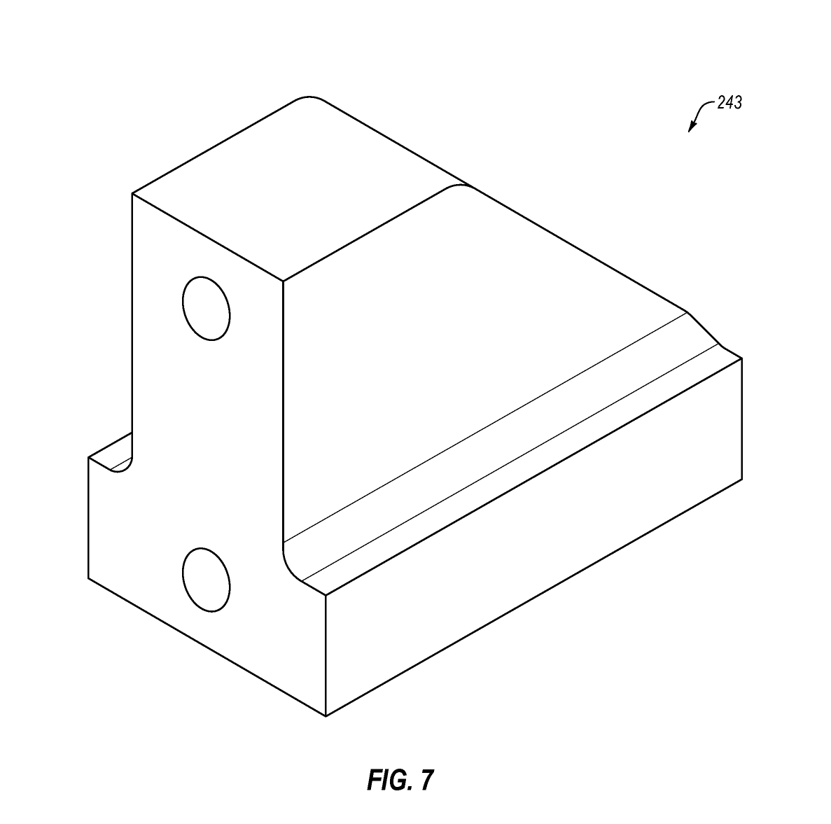

FIG. 6 illustrates an example a support member 233 of a roller guide assembly, in accordance with one or more embodiments. For example, with reference to FIG. 2, the support member 233 of FIG. 6 may be associated with the roller guide assembly 230 (e.g., the roller guide at an eight o'clock position). The support member 233 of FIG. 6 may be bolted or otherwise coupled to the stationary hub (e.g., the stationary hub 220) and to a bracket (e.g., the bracket 232). The coupling of the support member 233 to the bracket may be at an angle other than a right angle to facilitate proximity to a mounted motor. For example, the holes for coupling the bracket may be thirty degrees off from being at a right angle with the stationary hub.

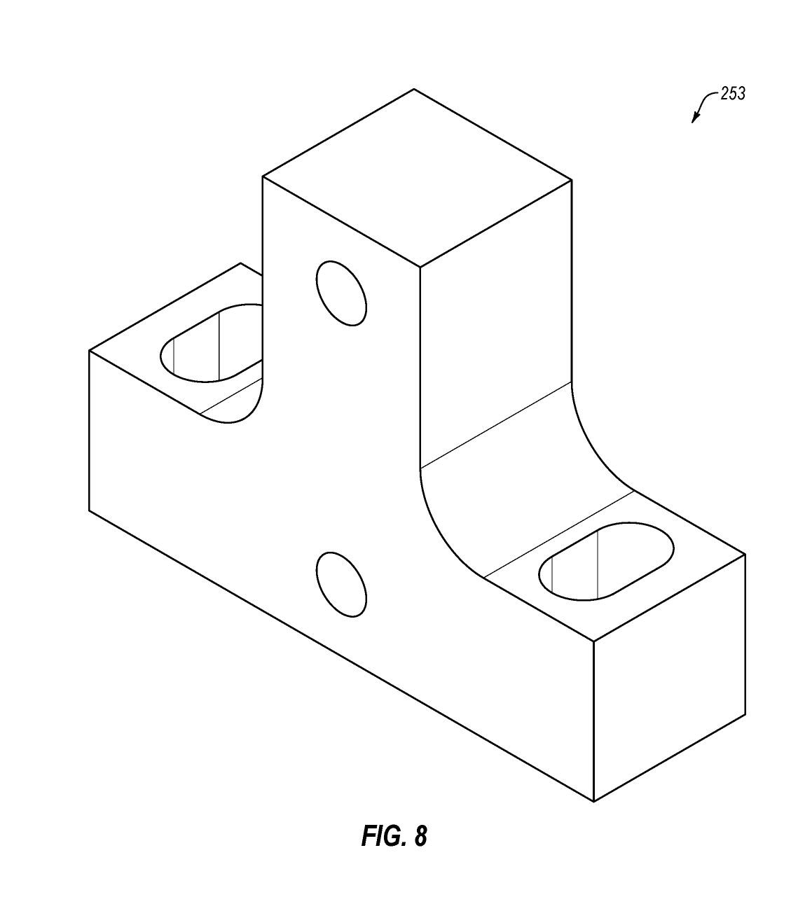

FIG. 7 illustrates another example support member 243 of a roller guide assembly, in accordance with one or more embodiments. For example, with reference to FIG. 2, the support member 243 of FIG. 7 may be associated with the roller guide assembly 240 (e.g., the roller guide assembly at a four o'clock position). The support member 243 of FIG. 7 may be bolted or otherwise coupled to the stationary hub (e.g., the stationary hub 220) and to a bracket (e.g., the bracket 242).

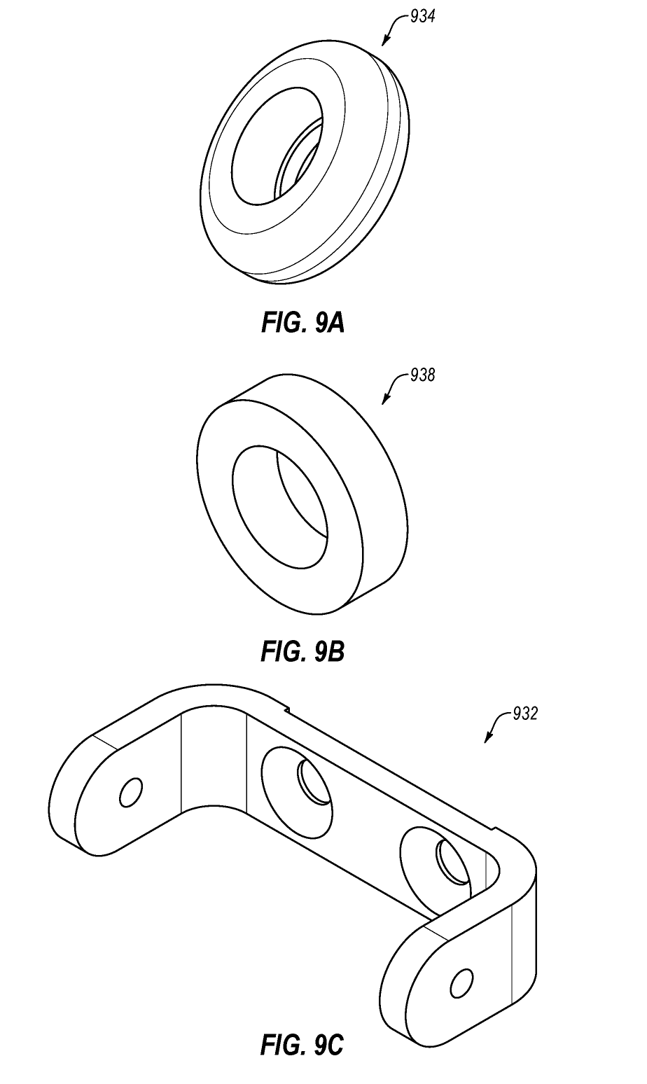

FIG. 8 illustrates another example support member 253 of a roller guide assembly, in accordance with one or more embodiments. For example, with reference to FIG. 2, the support member 253 of FIG. 8 may be associated with the roller guide assembly 250 (e.g., the roller guide assembly at a twelve o'clock position). The support member 253 of FIG. 8 may be bolted or otherwise coupled to the stationary hub (e.g., the stationary hub 220) and to a bracket (e.g., the bracket 252).

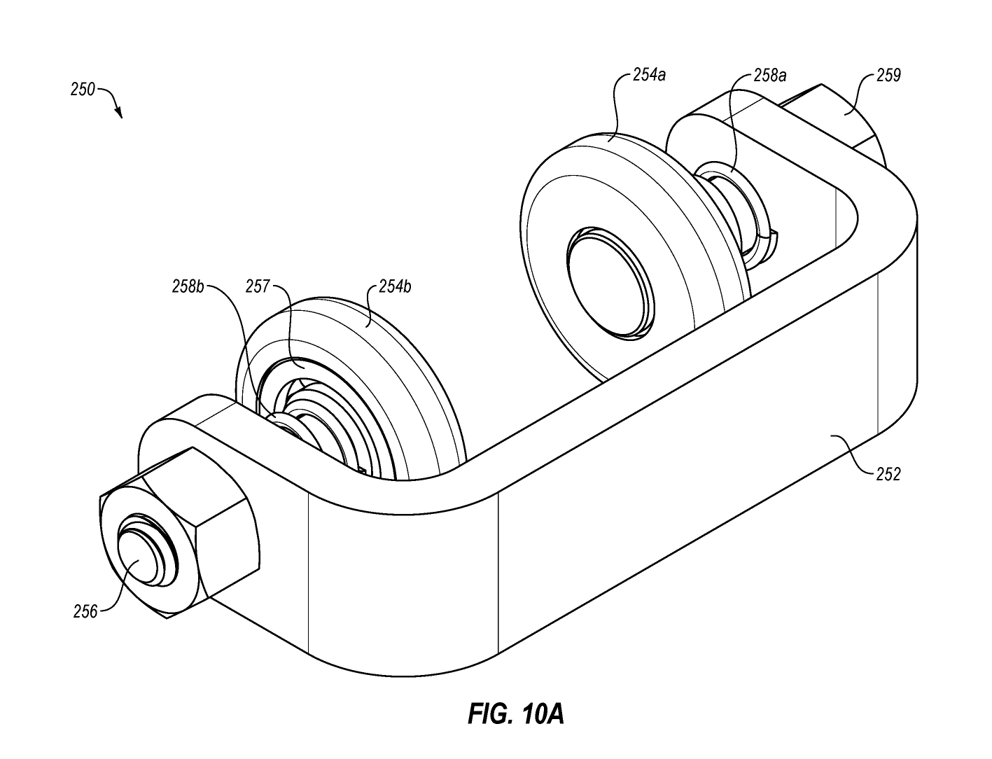

FIGS. 9A-9C illustrate various components of an example roller guide assembly, in accordance with one or more embodiments of the present disclosure. FIG. 9A illustrates an example roller guide 934, FIG. 9B illustrates an example roller spacer 938, and FIG. 9C illustrates an example bracket 932. The bracket 932 may support two roller guides (e.g., the roller guides 934) on an axle shaft (not shown). The axle shafts may be cantilevered from the bracket 932 (e.g., as illustrated in FIGS. 10A-C and 11). In some embodiments, a roller guide assembly may include the spacer 938 to facilitate the roller guide 934 rotating around the axle shafts at a desired location. Additionally or alternatively, the spacer 938 may be replaced by and/or include bearings to facilitate rotation of the roller guide 934 about the axle shaft.

FIGS. 10A-10C illustrate various views of portions of an example roller guide assembly 250 with a spring 258 (such as the springs 258a and 258b), in accordance with one or more embodiments of the present disclosure. FIG. 10A provides a perspective view, FIG. 10B provides a cutaway view, and FIG. 10C provides a side view of the roller guide assembly 250. While the roller guide assembly 250 is used as an example, any roller guide may also be compatible with the embodiment illustrated in FIGS. 10A-10C, such as the roller guide assemblies 230 and 240.

As illustrated in FIG. 10A, the roller guide assembly 250 may include the bracket 252, the roller guides 254a and 254b, an axle shaft 256, the spacer 257, the springs 258a and 258b and the nut 259. The axle shaft 256 may be threaded such that the nut 259 may couple the axle shaft 256 to the bracket 252. The springs 258a and 258b may bias the roller guides 254a and 254b, respectively, inwards from the edges of the bracket 252.

As illustrated in FIG. 10B, the springs 258a and 258b may bias the roller guides 254a and 254b, respectively, against a rim 1010. For example, the rim 1010 may have a profile with a gradual slope from a rail or other center point of the rim 1010 outwards towards the edges of the rim 1010. The springs 258a and/or 258b may bias the roller guides 254a and 254b against the rim 1010. For example, if the roller guides 254a and 254b start towards the edge of the rim 1010, as the roller guides 254a and/or 254b wear down or as the rim 1010 adjusts downward, the springs 258a and 258b may push the roller guides 254a and 254b, respectively, further up the incline of the rim 1010. Using the springs 258a and 258b may facilitate keeping the roller guides 254a and 254b, respectively, and/or the stationary hub 220 coupled to the centerless rim 1010.

FIG. 11 illustrates an exploded view of another example roller guide assembly 1150, in accordance with one or more embodiments of the present disclosure. In some embodiments, the roller guide assembly 1150 of FIG. 11 may illustrate one side of the roller guide assembly 250 of FIGS. 10A-10C. Additionally or alternatively, the roller guide assembly 1150 illustrated in FIG. 11 may include a roller guide assembly with a single roller guide 254 rather than two roller guides on each end of a bracket. For example, such an arrangement may be utilized for two wheel vehicles such as scooters, motorcycles, electric bikes, etc. in which loads are perpendicular to the angle of the roller guides such that axial or thrust loads are not as great. In comparison, in a four-wheeled vehicle or three wheeled vehicle (or a greater number of wheels where the wheels are in a side-by-side arrangement), the wheel assemblies may include roller guides on both sides of the rail to address considerations such as axial or thrust loads which may not be perpendicular to the angle of the roller guides.

As illustrated in FIG. 11, a bracket 1152 may include an arm that supports the roller guide 254 via the axle shaft 256. The roller guide assembly 1150 may include the spacer 257, the spring 258, and the nut 259. The roller guide assembly 1150 may operate in a similar manner to the roller guide assembly 250 of FIGS. 10A-10C. For example, the bracket 1152 may be positioned such that the roller guide 254 rolls along a rim and is biased towards the rim such that as the roller guide 254 wears down or as the rim moves due to external forces, the roller guide 254 may remain in contact with the rim.

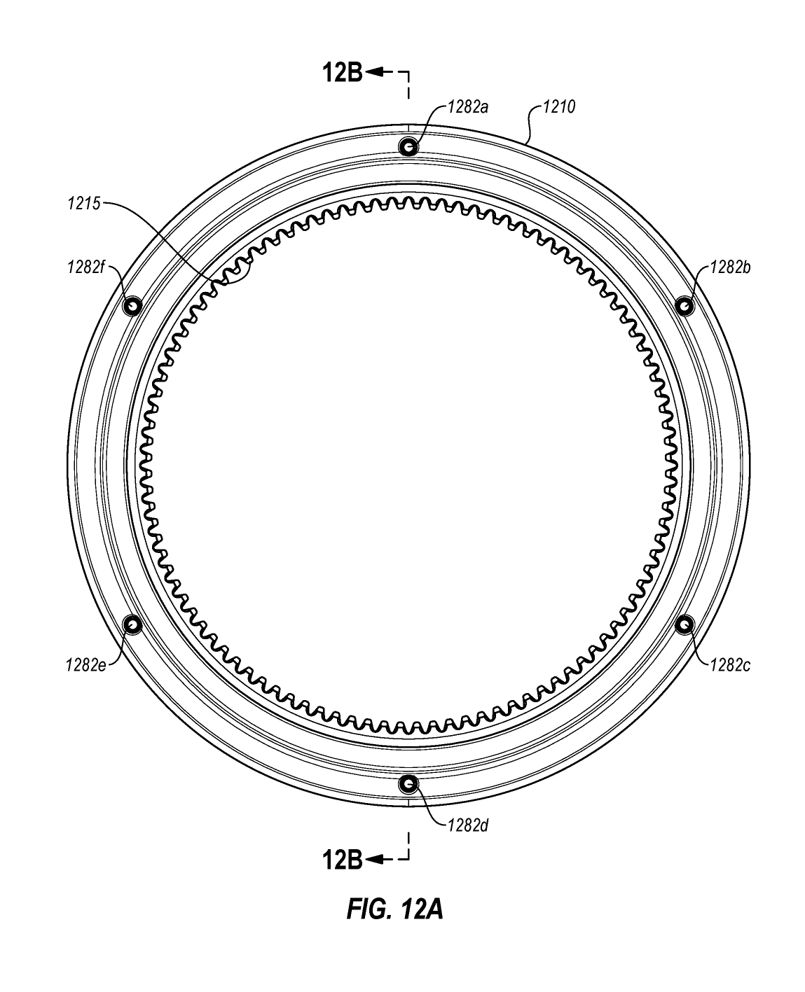

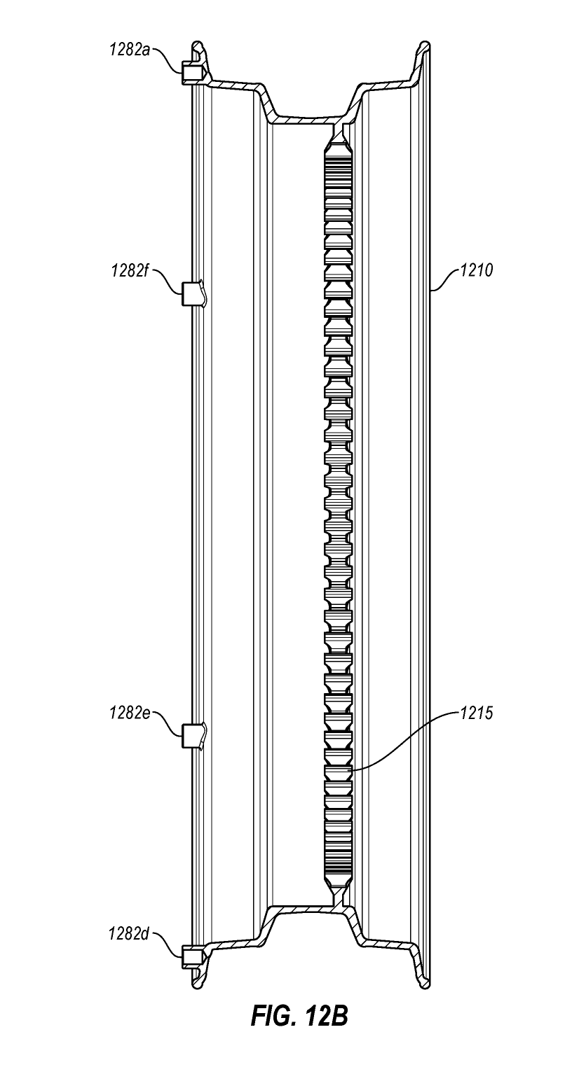

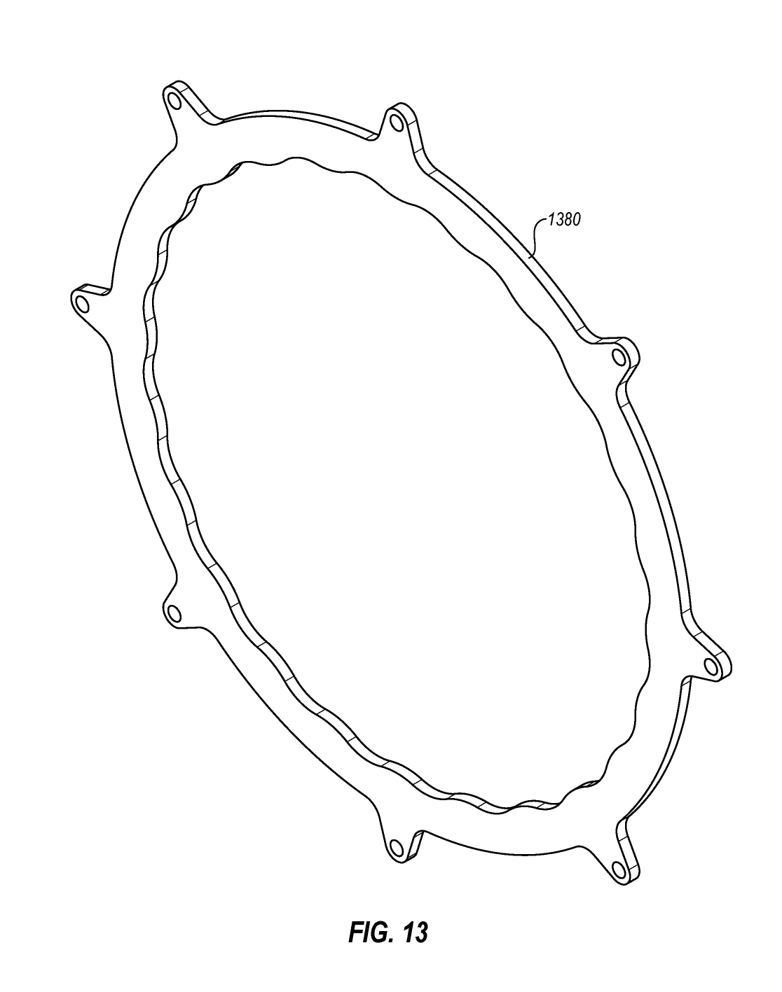

FIGS. 12A and 12B illustrate various view of an example centerless rim 1210, in accordance with one or more embodiments of the present disclosure. As illustrated in FIG. 12, the centerless rim 1210 may include a rail with teeth for interfacing with a drive gear. The centerless rim 1210 may additionally include multiple features 1282 (such as the six features 1282a-1282f, as illustrated in FIG. 12A) for coupling a brake rotor (such as that illustrated in FIG. 13) to the centerless rim 1210. The centerless rim 1210 may include a lip along which roller guides may roll. In these and other embodiments, the lip may include an incline from the edge of the centerless rim 1210 in towards the rail. In some embodiments, a profile of the centerless rim 1210 may include a central portion from which the rail projects.

In some embodiments the rail may be disposed off of the center of the central portion. By locating the rail off of the center, the rail may be further from where debris such as rocks or dirt may interfere with the drive gear and teeth of the rail.

In some embodiments, the gear teeth may be more narrow at a base proximate the rail and more broad at the end of the gear teeth (e.g., going from narrow to broad when observing the teeth from the edge of the rim 1210 and progressing towards a center of the rim 12010). In some embodiments, the gear teeth may include helical gear teeth, bevel gear teeth, spiral gear teeth, spiral bevel gear teeth, herringbone gear teeth, etc. In some embodiments, the gear teeth may be oriented as a crown gear. For example, the gear teeth may be oriented along a side of the rail, rather than along the apex of the rail as illustrated.

FIG. 13 illustrates an example brake rotor 1380 for coupling to a centerless rim, in accordance with one or more embodiments of the present disclosure. The brake rotor 1380 may rotate with the centerless rim, and a brake caliper may be coupled to a stationary hub. The brake caliper may be sized and positioned such that the brake rotor 1380 rotates freely through the brake caliper, and if invoked, the brake caliper interacts with the brake rotor 1380 to slow down the brake rotor 1380, and thus the centerless rim.

Modifications, additions, or omissions may be made to any of the FIGS. 2-13 without departing from the scope of the present disclosure. For example, a centerless wheel assembly may include more or fewer elements than those illustrated and described in the present disclosure.

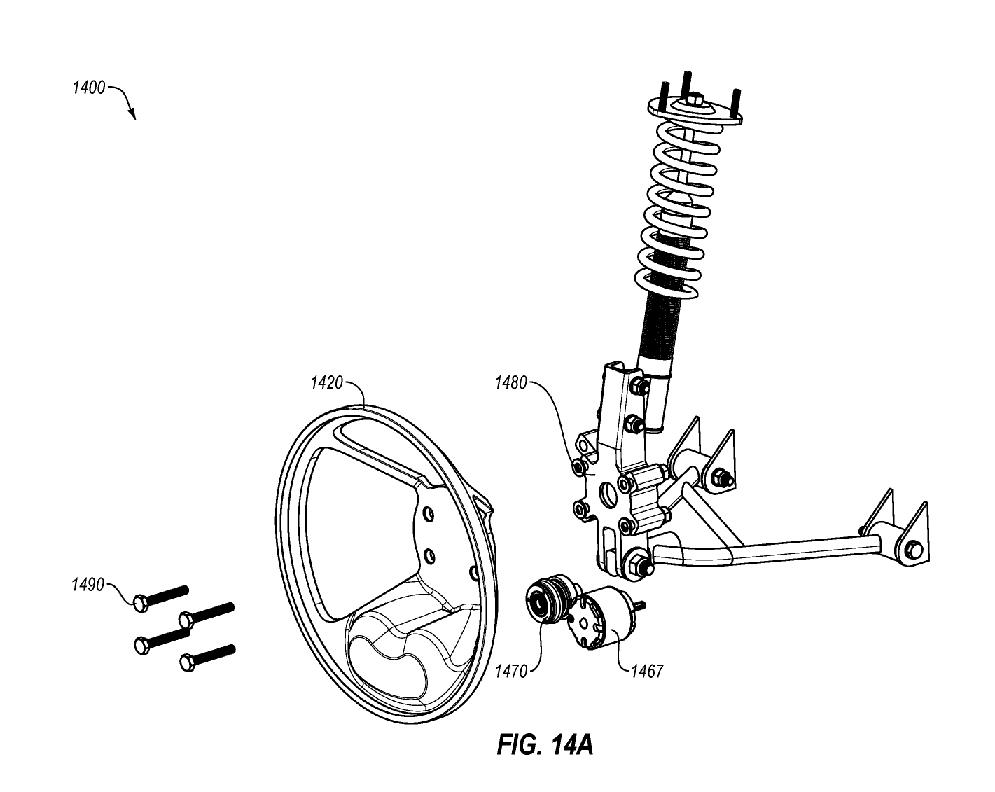

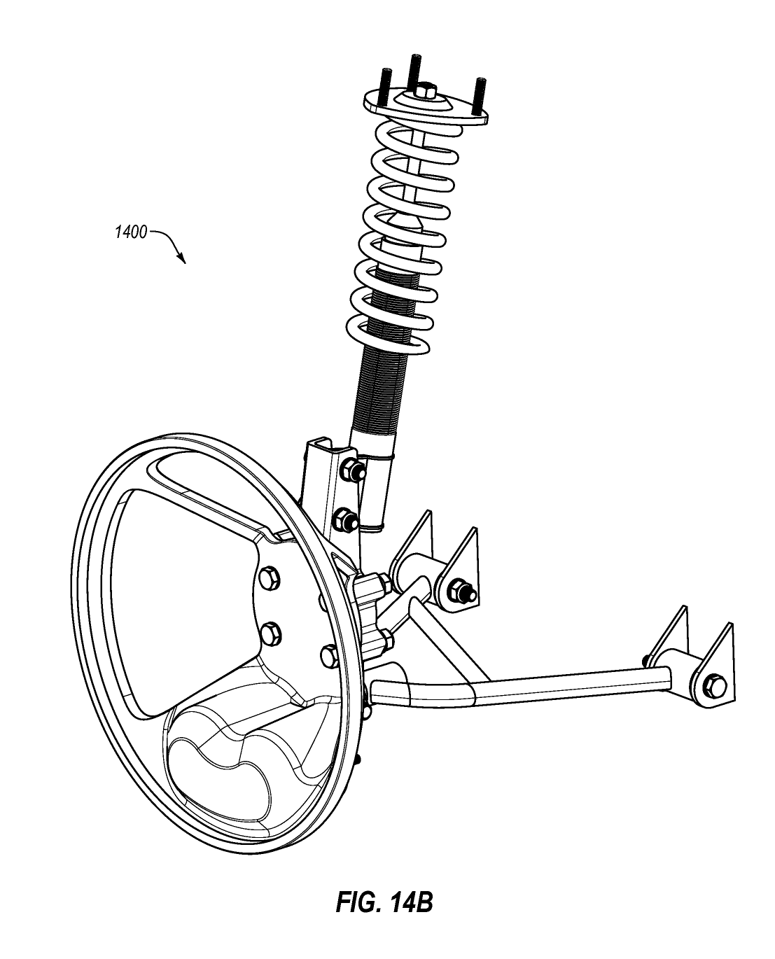

FIGS. 14A and 14B illustrate an embodiment of attaching an example wheel assembly 1400 to an example wheel arm 1480, in accordance with one or more embodiments of the present disclosure. The wheel assembly 1400 may include a stationary hub 1420 that may be similar or comparable to the stationary hub 120 and/or 220 of the present disclosure. For convenience, the stationary hub 1420 may be illustrated, while other components (e.g., a centerless rim, tire, drive gear, roller guide assemblies, etc.) may not be illustrated.

As illustrated in FIGS. 14A and 14B, the stationary hub 1420 may include a central portion with bolt holes or other coupling features configured to couple the stationary hub to a wheel arm 1480. In some embodiments, bolts 1490 may be used to couple the stationary hub 1420 to the wheel arm 1480. Additionally or alternatively, lug posts or other components of the wheel arm 1480 may project through the coupling features of the stationary hub 1420. For example, the bolt holes may be aligned and shaped to match a traditional automobile wheel such that the stationary hub 1420 may be coupled to a traditional wheel arm of an automobile, such as via lug nut studs, etc. The bolt holes may be aligned and shaped to interface with any vehicle, such as a bus, car, truck, moped, motorcycle, all-terrain vehicle, four wheeler, race car, etc.

As illustrated in FIGS. 14A and 14B, even if coupling to a traditional wheel arm (e.g., if the wheel arm 1480 is part of an existing vehicle such that the wheel assembly 1400 is being retrofitted to an existing vehicle), the stationary hub 1420 may include a motor 1470 and/or a transmission component 1467. The motor 1470 may drive the wheel assembly 1400. The transmission component 1467 may translate the motive force of the motor 1470 to a drive shaft and/or a drive gear (not illustrated).

In these and other embodiments, the wheel assembly 1400 of the present disclosure may be coupled with the wheel arm 1480, taking advantage of steering mechanisms and mechanisms to support a vehicle while still utilizing a wheel consistent with the present disclosure.

As illustrated in FIGS. 14A and 14B, the stationary hub 1420 may be shaped such that arms may project outwards from a central region for coupling with the wheel arm 1480. The outer regions of the stationary hub 1420 may be configured to support one or more roller guide assemblies, brake rotors, etc. Additionally or alternatively, the stationary hub 1420 may be configured to interface with another component, such as an external exoskeleton plate (e.g., an additional stationary hub positioned on the opposite side of the wheel assembly 1400 from the wheel arm 1480, that may be configured to support one or more such components, such as roller guide assemblies, brake rotors, etc.

As described above, a simple stationary hub is illustrated. In these and other embodiments, an exoskeleton plate may also be used as the stationary hub. In such an embodiment, a centerless wheel may be coupled to a wheel arm 1480, such as the centerless wheel assembly of U.S. application Ser. Nos. 15/146,729 and/or 15/336,540, which are incorporated by reference herein in their entirety.

Modifications, additions, or omissions may be made to FIG. 14 without departing from the scope of the present disclosure. For example, the stationary hub 1420 may take any shape or form, such as those illustrated in any of the figures of the present disclosure or the applications incorporated by reference. As another example, the wheel arm 1480 may take any form or shape, depending on the vehicle. As an additional example, the bolt holes and/or coupling features may take any form or shape, depending on the wheel arm 1480.

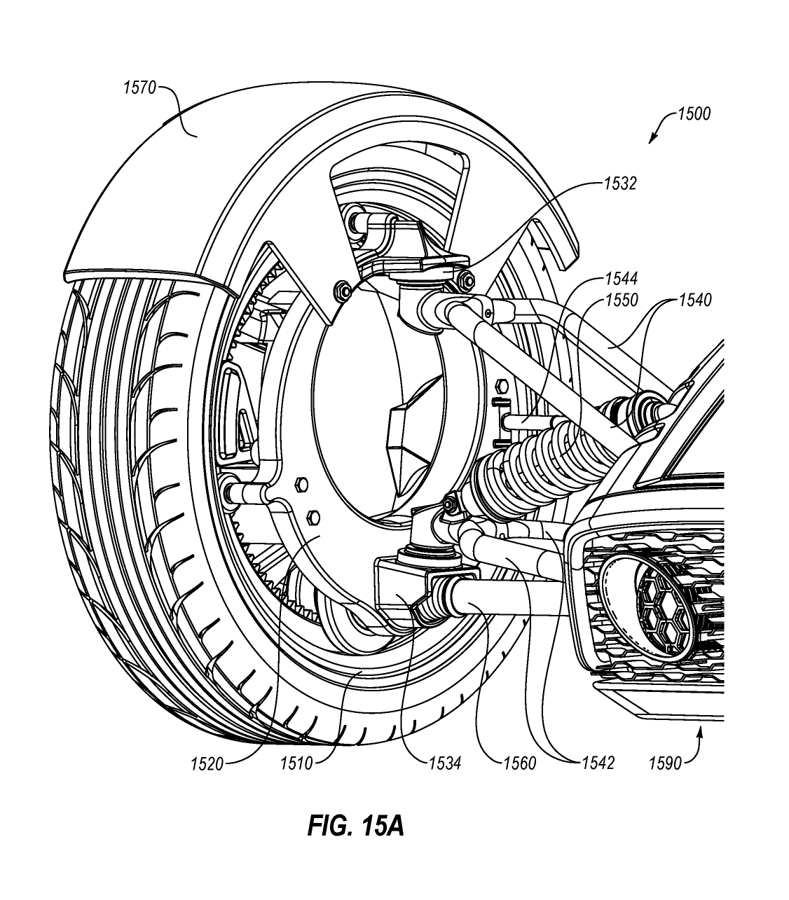

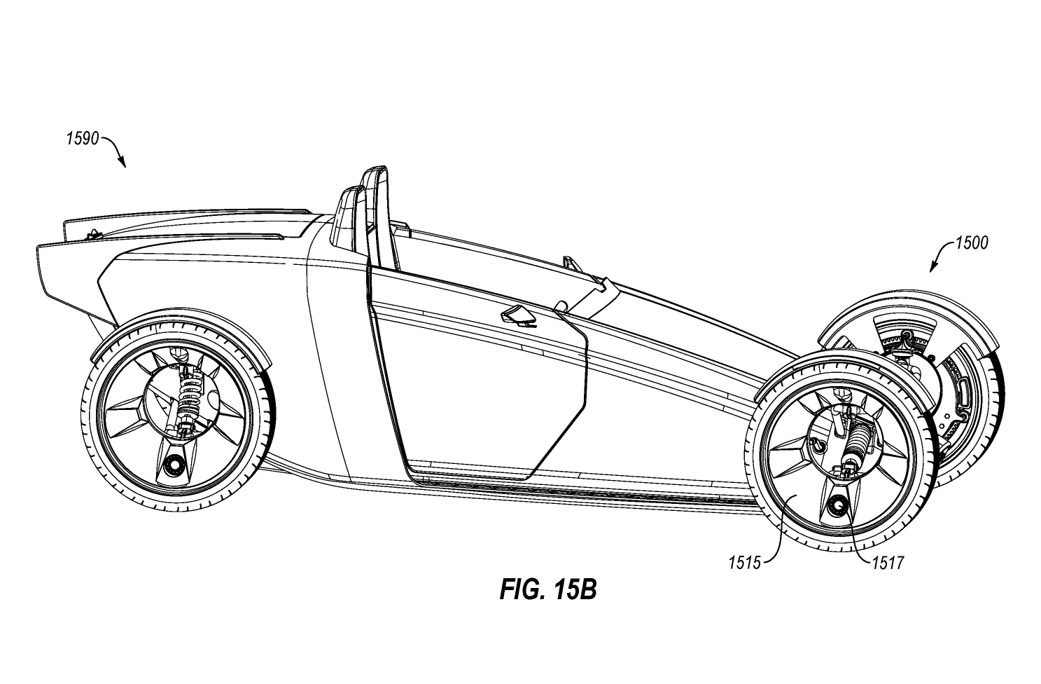

FIGS. 15A and 15B illustrate an automobile 1590 with a wheel assembly 1500 coupled to a wheel arm, in accordance with one or more embodiments of the present disclosure.

In some embodiments, the wheel assembly may be coupled to a wheel arm as illustrated in FIG. 14. In some embodiments, the wheel assembly 1500 may be coupled to a wheel arm or arms as illustrated in FIG. 15A.

As illustrated in FIG. 15A, the wheel assembly 1500 may include a centerless rim 1510 and a stationary hub 1520. The centerless rim 1510 and the stationary hub 1520 may be used in a manner similar or comparable to the similarly named components in FIGS. 1 and 2. In some embodiments, the stationary hub 1520 may interface with an upper suspension 1540, a lower suspension 1542, and/or a mid-suspension 1544. The stationary hub 1520 may include interfaces for any of a variety of an upper suspension interface 1532 and/or a lower suspension interface 1534. The stationary hub may also interface with a shock absorber 1550 that may interface with one or more of the suspensions (such as the lower suspension 1542).

In these and other embodiments, the upper, lower, and mid suspensions 1540, 1542, and 1544 may be positioned on the wheel assembly 1500 in a unique way to provide greater support and greater flexibility to the automobile 1590. For example, because the stationary hub 1520 provides a larger area that is not rotating relative to a tire of the wheel assembly 1500 when compared to a traditional wheel, the various suspensions may utilize a broader connection point to the wheel assembly 1500, providing a more stable suspension. Additionally or alternatively, by using a multi-component suspension and/or wheel arm, the void in material near the middle of the stationary hub 1520 may be maintained. Such a void may yield a reduction in mass and/or aesthetic benefit. Additionally, such an arrangement may reduce any tendencies for a wheel to lift off of the ground due to the location of the coupling between the upper, lower, and mid suspensions 1540, 1542, and 1544 and the stationary hub 1520. As another example, the wheel camber angle may be maintained at angles off-parallel from the ground plane when cornering in a multi-wheel vehicle.

In some embodiments, a steering component may also be coupled to the stationary hub 1520. For example, a steering bar 1560 may be directly coupled to the stationary hub 1520, such as via an interface proximate to or part of the lower suspension interface 1534.

FIG. 15B illustrates an outside view of the automobile 1590. As illustrated in FIG. 15B, the wheel assembly 1500 may include an exterior stationary hub 1515 that may act as a facade for the wheel assembly 1500. In some embodiments, the exterior stationary hub 1515 may provide an aesthetic benefit, may provide protection for an inner region of the wheel assembly 1500, etc. In some embodiments, one or more roller guide assemblies and/or brake calipers may be supported by the exterior stationary hub 1515. In these and other embodiments, the exterior stationary hub 1515 may be maintained in place via a nut 1517. The nut 1517 may serve to maintain the exterior stationary hub 1515 in contact with the stationary hub 1520 (not visible in FIG. 15B).

Modifications, additions, or omissions may be made to FIGS. 15A and 15B without departing from the scope of the present disclosure. For example, the stationary hub 1520 may take any shape or form, such as those illustrated in any of the figures of the present disclosure or the applications incorporated by reference. As another example, the suspensions 1540, 1542, and/or 1544 and/or steering bar 1560 may take any form or shape, depending on the vehicle. As an additional example, the wheel assembly 1500 may include additional or fewer components than those illustrated in FIGS. 15A and 15B.

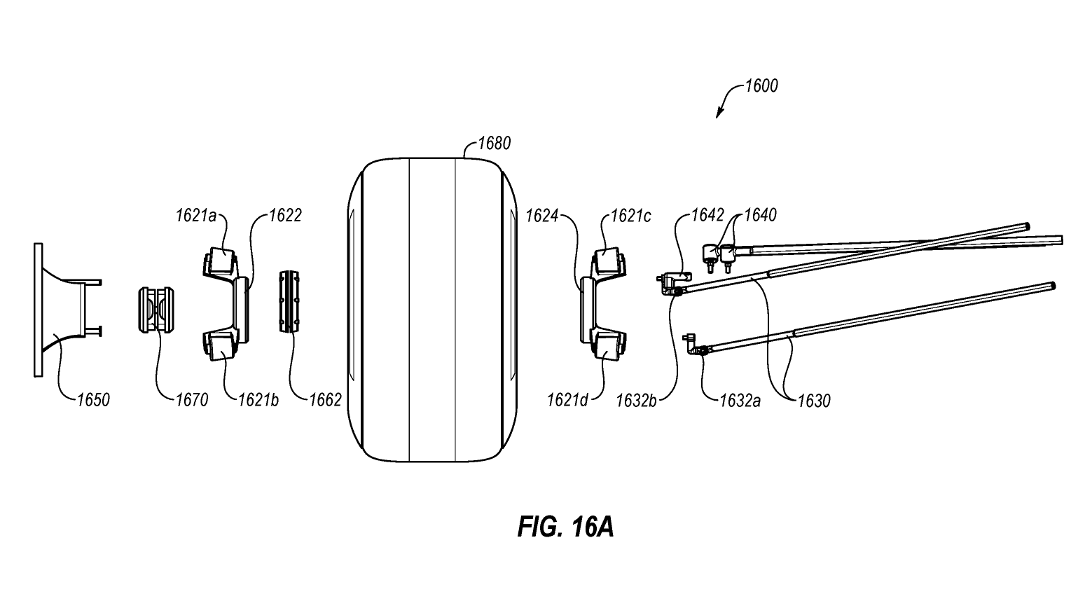

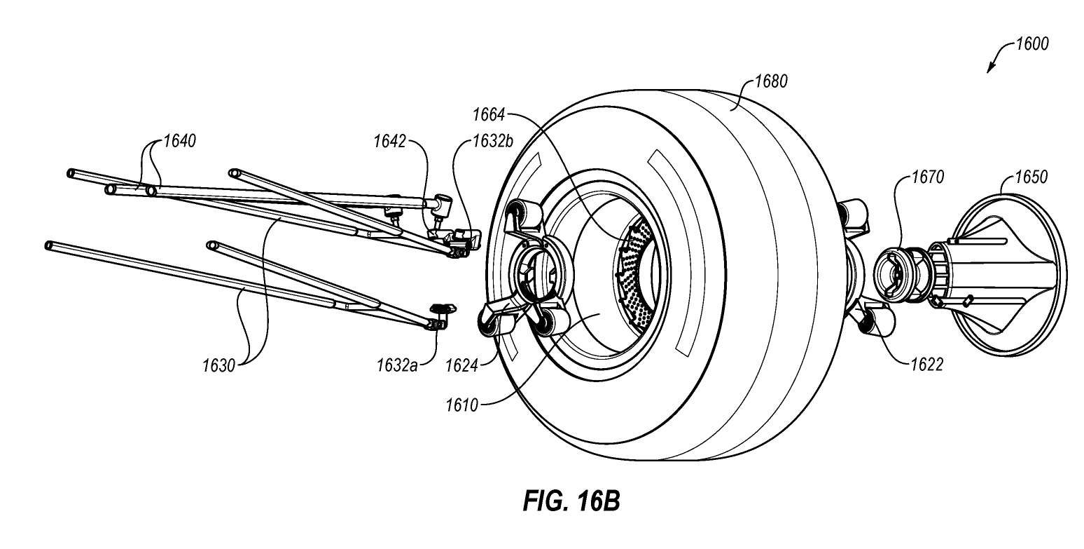

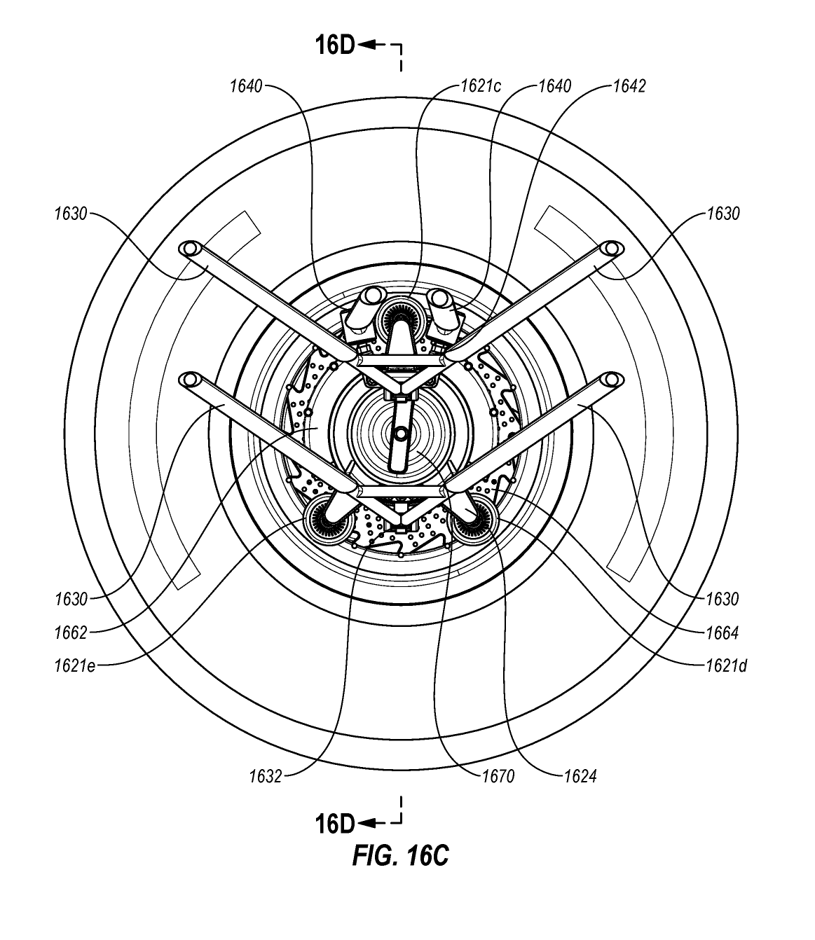

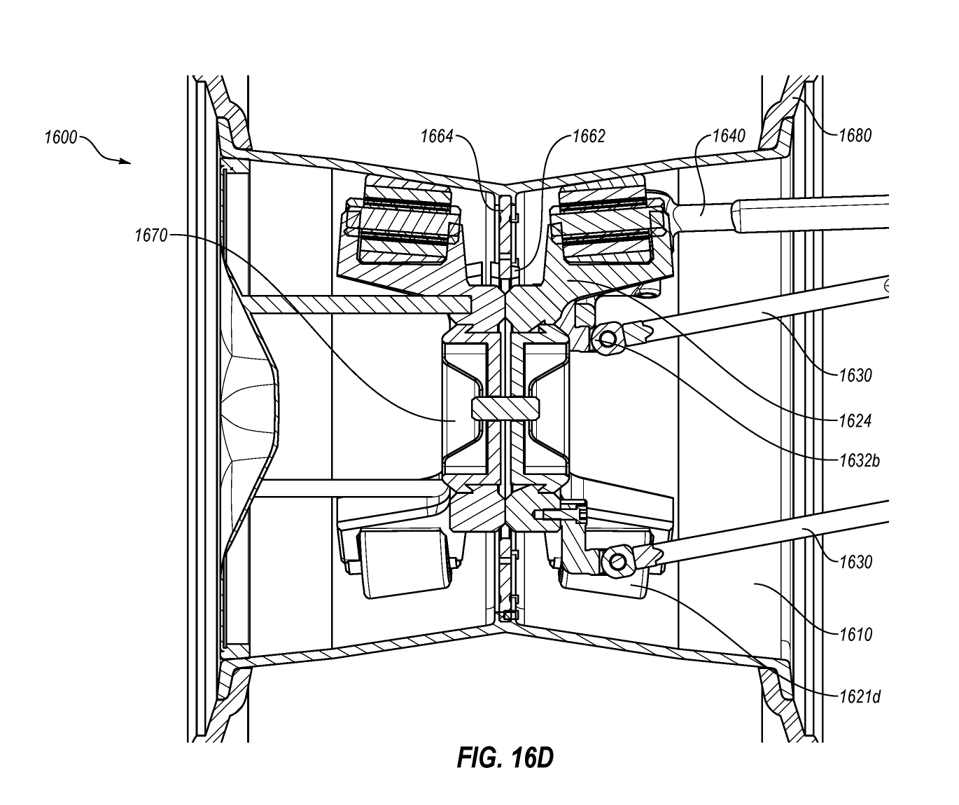

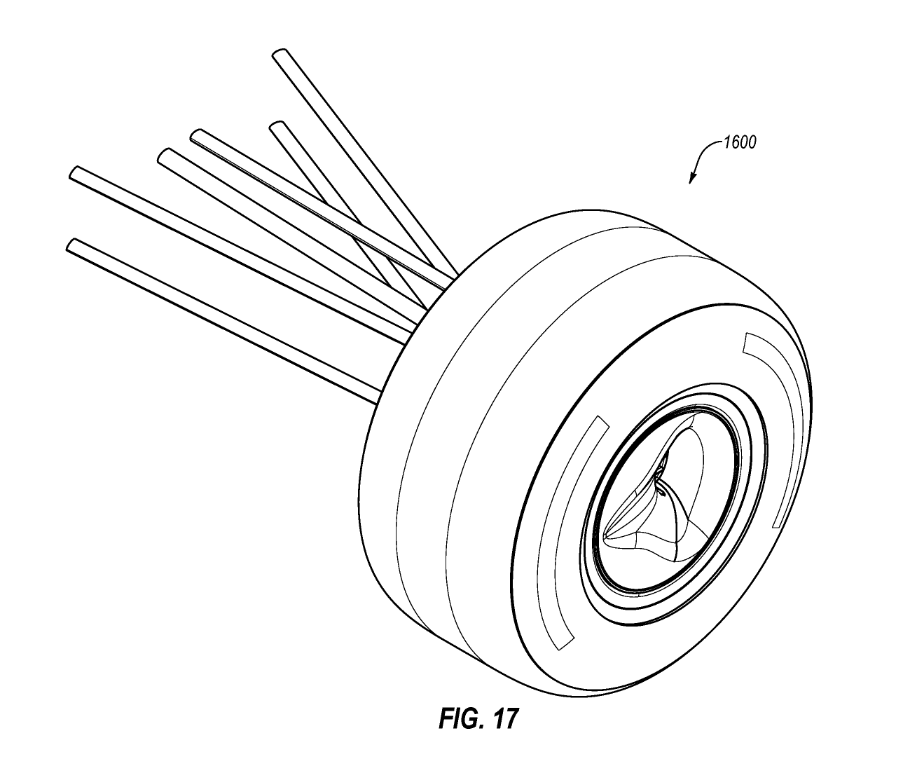

FIGS. 16A-16D illustrate various views of another example wheel assembly 1600, in accordance with one or more embodiments of the present disclosure. The wheel assembly 1600 may be configured to interface with a race car or other high performance vehicle. FIG. 16A provides an exploded side view of the wheel assembly 1600. FIG. 16B provides an exploded perspective view of the wheel assembly 1600. FIG. 16C provides a back view of the wheel assembly 1600 as viewed from a vehicle.

The wheel assembly 1600 may include a centerless rim 1610, an external stationary hub 1622 with roller guides 1621a and 1621b, an internal stationary hub with roller guides 1621c and 1621d, a lower suspension 1630 with a lower suspension holders 1632a and 1632b, an upper suspension 1640 with upper suspension holder 1642, an air vent 1650, a brake caliper 1662, a brake rotor 1664, a locking nut 1670, and a tire 1680.

The wheel assembly 1600 may be coupled to a vehicle via the suspension arms of the lower suspension 1630 and the upper suspension 1640. The lower suspension 1630 and the upper suspension 1640 may be coupled to the internal stationary hub 1624 via the lower suspension holders 1632a/1632b and 1642, respectively. Because the internal stationary hub 1624 is able to be disposed within the central region of the wheel assembly 1600, the vehicle may couple with the wheel assembly 1600 at a point closer to a center line of the tire 1680, rather than at the outside face of the tire 1680. Because the suspensions 1630 and 1640 couple with the wheel assembly 1600 closer to the center line of the tire 1680, greater control of wheel camber may be obtained. In these and other embodiments, greater control may be provided in keeping the tire 1680 perpendicular with the road surface, even when cornering or when experiencing other forces. In some embodiments, the wheel assembly 1600 may be configured such that the coupling point of the suspensions 1630 and 1640 may be shifted even further away from the inside face of the tire 1680 than a center line of the tire 1680. Additionally or alternatively, the coupling point of the suspensions 1630 and 1640 may be located between the inside face of the tire 1680 and the center line of the tire 1680. In some embodiments, the wheel assembly 1600 may be configured such that a line drawn through the coupling points of the suspensions 1630 and 1640 may intersect a ground plane formed by the edge of the tire 1680 and the ground in the center of the tire 1680.

As illustrated in FIG. 16D, in some embodiments, the profile of one or more of the roller guides 1621 (e.g., 1621a-1621d) may be frustoconical in shape, such that a cut-away view of the roller guides appears to be trapezoidal. In some embodiments, one or more sides of the roller guides 1621 may be configured to be generally parallel with the profile of centerless rim 1610, such that the one or more sides of the one or more roller guides 1621 may maintain contact with the centerless rim 1610 during rotation of the centerless rim 1610 and/or the one or more roller guides 1621. In some embodiments, the one or more sides of the roller guides 1621 may be configured such that the one or more sides of the roller guides 1621 may not be generally parallel to the axis of rotation created by the one or more shafts acting as an axle for the roller guides 1621 coupled to the exterior and/or interior stationary hubs 1622 and 1624. For example, the axis of rotation of the one or more such shafts may be generally coincident with a line running through the apex and the center of the base of the cone of the frustoconical shape. In these and other embodiments, such a line may or may not be parallel with any portions or facets of the centerless rim 1610.

In some embodiments, the orientation of the roller guides 1621a and 1621b on the external stationary hub 1622 may be oriented in a first direction (e.g., such that the axis of rotation of each of the roller guides converges at some point beyond the internal face of the wheel assembly 1600), and the orientation of the roller guides 1621c and 1621d on the internal stationary hub 1624 may be oriented in a second direction (e.g., such that the axis of rotation of each of the roller guides converges at some point beyond the external face of the wheel assembly 1600). In these and other embodiments, the centerless rim 1610 may include two inclined faces meeting at approximately a mid point of a profile of the centerless rim 1610. For example, as illustrated in FIG. 16D, both sides of the centerless rim 1610 incline towards an apex at about the mid point of the profile of the centerless rim. Such an arrangement when used in a four-wheeled vehicle or three wheeled vehicle (or a greater number of wheels where the wheels are in a side-by-side arrangement) may provide certain advantages. For example, the wheel assemblies may include roller guides on both sides of the rail to address considerations such as axial or thrust loads which may not be perpendicular to the angle of the roller guides. Doing so may facilitate control of camber angles that are off-parallel when cornering. For example, when turning right, the inside roller guides 1621c/1621d of the right wheel and the outside roller guides 1621a/1621b of the left wheel bear the brunt of the g-forces, and vice versa.

In some embodiments, the external stationary hub 1622 and/or the internal stationary hub 1624 may be threaded in a central region such that the locking nut 1670 may screw into both the external stationary hub 1622 and/or the internal stationary hub 1624. While a locking nut 1670 is illustrated, any such coupling mechanism may be utilized, such as a cam-lock

The air vent 1650 may be a coupled to the exterior stationary hub 1622 such that the air vent 1650 remains stationary relative to the rotation of the tire 1680. As the air vent 1650 travels laterally due to motion of the vehicle to which the wheel assembly 1600 is coupled, the air vent 1650 may be shaped and configured to draw air into the central region of the wheel assembly 1600. By drawing the air into the central region, the air may cool the brake rotor 1664 to improve braking performance and to increase the life of the braking components. Additionally, because of the cooling provided to the brake rotor 1664, the brake rotor 1664 may be made of a lighter material. Also, the cooling air may facilitate a decrease in fading (e.g., a decrease in reduction in brake responsiveness due to excessive heat), as friction between the brake rotor 1664 and the brake caliper 1662 generate heat. Also, the brake caliper 1662 may be designed to have greater overlap with the brake rotor 1664 (e.g., brake swept area) due to the increased cooling effect of the air vent 1650, yielding increased braking performance. In addition, because the air vent 1650 remains stationary relative to the rotating tire 1680, and because the internal stationary hub 1624 remains stationary relative to the rotating tire 1680, the aerodynamic drag may be reduced.

The various components of the wheel assembly 1600 may facilitate a reduction in the moment of inertia (e.g., the torque that cuases angular acceleration). For example, due to the void of material in the central region of the wheel assembly 1600, the mass of the wheel assembly 1600 is reduced so that it is easier to rotate the wheel assembly 1600. Additionally, due to the void of material in the central region of the wheel assembly 1600, the unsprung weight (e.g., the weight of the suspension and components directly connected to the suspension, rather than being supported by the suspension) may be reduced. The reduced unsprung weight may yield greater control in hard acceleration and hard braking, which may be frequently experienced by racing cars. Additionally, in some embodiments, there may be a reduction in the coefficient of static and dynamic friction between the roller guides 1621 and the centerless rim 1610 because of the small amount of contact between the roller guides 1621 and the centerless rim 1610.

In some embodiments, such an arrangement may provide improvements for short long arm suspensions (SLAs). As used herein, an SLA may include a suspension with an upper arm that is a different length (often shorter) than the lower arm. The upper arm may include an A-arm (or alternatively, any other type of suspension arm such as an L-arm), and the lower arm may include an A-arm, an L-arm, or a set of tension/compression arms (or any other type of suspension arm). In these and other embodiments, the four-bar linkage formed by the unequal arm lengths causes a change in the camber of the vehicle as it rolls, which may facilitate keeping a contact patch of a tire squarely on the ground, which may increase the cornering capability of the vehicle, while also reducing the wear at the outer edges of the tire. In these and other embodiments, SLAs with long arms may enjoy improved kingpin geometry as compared to SLAs with shorter arms. However, some SLAs with long arms may be in proximity to the tire and thus may not be usable with oversized tires. In accordance with embodiments of the present disclosure, because of the linkage of the suspension to the stationary hub at a location within the wheel assembly 1600. Because of the arrangements of the present disclosure, such long arm SLAs may be utilized in conjunction with large tires, such as for racing cars as illustrated in FIGS. 16A-16D and 17.

The locking nut 1670 may be shaped and configured such that the wheel assembly 1600 may be rapidly and easily removed from the vehicle and a new wheel placed on the vehicle to replace the removed wheel assembly.

FIG. 17 illustrates another view of the example wheel assembly of FIGS. 16A-16D, in accordance with one or more embodiments of the present disclosure. FIG. 17 illustrates a perspective and unexploded view of the wheel assembly 1600.

Modifications, additions, or omissions may be made to FIGS. 16A-16D and/or 17 without departing from the scope of the present disclosure. For example, the roller guides 1621 may take any form or shape. As another example, the wheel assembly 1600 may be implemented with a single stationary hub supporting both internal and external roller guides (e.g., the roller guides on both sides of the centerless rim 1610). As another example, the air vent 1650 may be removed or have a different shape, profile, etc. for aerodynamic purposes, for airflow purposes, or for any other design consideration. As an additional example, the wheel assembly 1600 may include additional or fewer components than those illustrated in FIGS. 16A-D and 17.

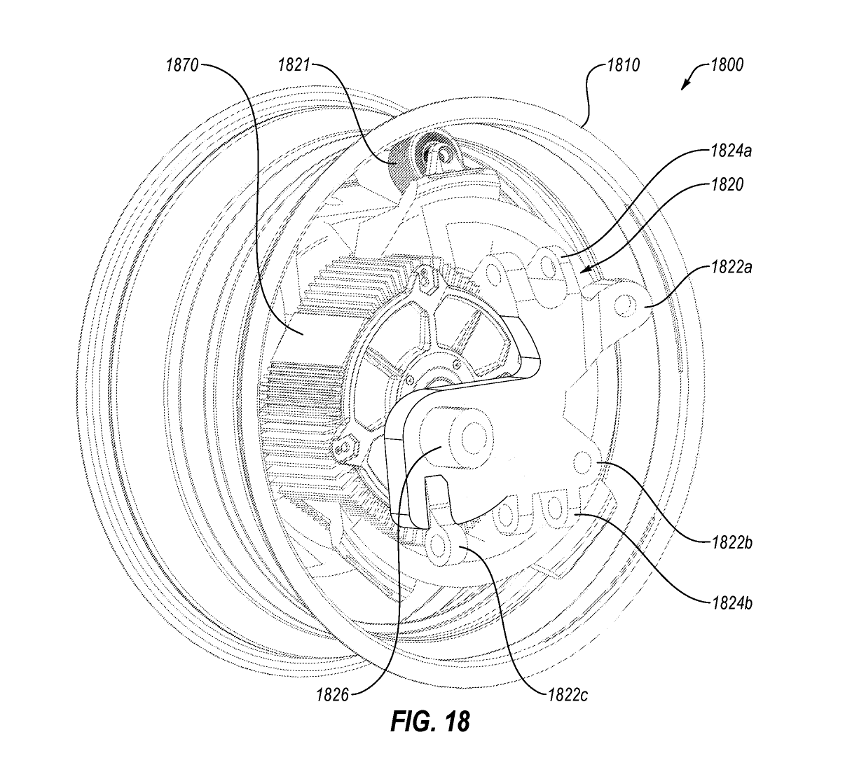

FIG. 18 illustrates another example wheel assembly 1800, in accordance with one or more embodiments of the present disclosure. The wheel assembly 1800 may be configured to retrofit with an existing vehicle. In particular, at least portions of a typical wheel mount may be removed from the vehicle being retrofitted, such as the brake rotor, the spindle, all or part of the steering knuckle, etc. Instead, suspension arms, steering arms, ball joints, control arms, strut rods, etc. that typically couple with the knuckle or other mounting components for the wheel may instead couple directly with the wheel assembly 1800.

The wheel assembly 1800 may include a centerless rim 1810, a stationary hub 1820 with roller guides 1821 (only one roller guide is illustrated for convenience) and one or more joints/coupling (described below), and/or a motor 1870. For each of the wheel assembly 1800, the centerless rim 1810, and/or the stationary hub 1820, the respective components may include any of the features and/or modifications of other embodiments of similarly named components of the present disclosure, and may be similar or comparable to other embodiments of the present disclosure.

As illustrated in FIG. 18, the stationary hub 1820 may include an upper mount 1824a for the upper ball joint/control arm/suspension to couple to the stationary hub 1820, and a lower mount 1824b for the lower ball joint/lower control arm, etc. to couple to the stationary hub 1820. The stationary hub 1820 may also include a central mount 1826 that may facilitate coupling a stabilizer bar or other component to the stationary hub 1820. The stationary hub 1820 may additionally or alternatively include one or more alternative mounts 1822, such as the alternative mounts 1822a, 1822b, and/or 1822c (e.g., which may support a tie rod end).

While one potential arrangement of various mounts is illustrated, it will be appreciated that any configuration of mounts is contemplated within the scope of the present disclosure, as various makes and/or models of vehicles may have different locations and/or mounting components. For whatever style or location of mounting used, those components may be retrofitted with a mounting on the stationary hub 1820 to remove unnecessary components to facilitate a decrease in weight.

In some embodiments, between the alternative mount 1822a and the upper ball joint 1824a, any components of a traditional wheel mounting that may couple to the steering knuckle or other upper portions of the wheel mounting may be coupled to the stationary hub 1820 instead.

In some embodiments, the motor 1870 may include any motor, such as an electric motor. In some embodiments, because of the gearing ratios between a drive gear (not shown) and the centerless rim 1810, the motor may be a high-speed electric motor.

Additionally or alternatively, in some embodiments, the motor 1870 may be located inboard from the wheel assembly 1800. For example, the motor 1870 may be mounted somewhere on the vehicle and there may be a mechanical linkage between the vehicle-mounted motor and a drive gear (not illustrated) or other component to drive the centerless rim 1810. In these and other embodiments, such a mechanical linkage may include a halfshaft with a constant-velocity (CV) joint at one or both ends. Additionally or alternatively, a belt, chain, or other force-transferring device may couple the motor to the drive gear.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” the term “containing” should be interpreted as “containing, but not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

The drawings included herein are for example purposes only, and may not be drawn to scale. For example, various components may be omitted or additional components may be included. Additionally, the various components of the drawings may be oriented in different directions or coupled in various manners and be within the scope of the present disclosure.

All examples and conditional language recited in the present disclosure are intended for pedagogical objects to aid the reader in understanding the disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A wheel comprising:
a centerless rim that includes a rail with a driving feature, the rail protruding towards a middle of the centerless rim in a first plane;
a stationary hub, the stationary hub positioned along a second plane generally parallel with the first plane;
a first roller guide assembly, the first roller guide assembly including:
a first support member coupled to the stationary hub and configured to bridge the rail;
a first roller guide coupled to the first support member and positioned to roll along the centerless rim adjacent the rail on a first side of the rail;
a second roller guide coupled to the first support member and positioned to roll along the centerless rim adjacent the rail on a second side of the rail opposite the first side; and
a spring positioned to bias the first roller guide against the centerless rim.

2. The wheel of claim 1, further comprising:
a second roller guide assembly, the second roller guide assembly including:
a second support member coupled to the stationary hub and configured to bridge the rail;
a third roller guide coupled to the second support member and positioned to roll along the centerless rim adjacent the rail on the first side of the rail; and
a fourth roller guide coupled to the second support member and positioned to roll along the centerless rim adjacent the rail on the second side of the rail; and
a third roller guide assembly, the third roller guide assembly including:
a third support member coupled to the stationary hub and configured to bridge the rail;
a fifth roller guide coupled to the third support member and positioned to roll along the centerless rim adjacent the rail on the first side of the rail; and
a sixth roller guide coupled to the third support member and positioned to roll along the centerless rim adjacent the rail on the second side of the rail.

3. The wheel of claim 1, further comprising:
a first axle shaft coupled to the first support member and around which the first roller guide rotates; and
a second axle shaft coupled to the first support member and around which the second roller guide rotates.

4. The wheel of claim 1, further comprising a toothed gear interfacing with the driving feature of the rail.

5. The wheel of claim 4, further comprising a motor coupled to the toothed gear such that as the motor drives the toothed gear, the centerless rim rotates.

6. The wheel of claim 1, wherein the stationary hub includes a void in material proximate a middle of the stationary hub.

7. The wheel of claim 1, wherein the stationary hub includes bolt holes proximate a middle of the stationary hub, the bolt holes corresponding to lug nut studs.

8. The wheel of claim 1, wherein the centerless rim includes an incline along at least a portion of the centerless rim from the rail to an outer edge of the centerless rim.

9. The wheel of claim 8, wherein the spring is configured to push the first roller guide further up the incline as the first roller guide experiences wear.

10. The wheel of claim 1, wherein the stationary hub comprises a suspension interface shaped to couple with a suspension arm of a vehicle.

11. A wheel comprising:
a centerless rim, the centerless rim including a void in material in a central region of the centerless rim;
an internal stationary hub disposed within the central region of the centerless rim and configured to be positioned on a vehicle-facing side of the wheel;
a first roller guide coupled to the internal stationary hub and configured to roll along the centerless rim;
an external stationary hub disposed within the central region of the centerless rim and configured to be positioned opposite the vehicle-facing side of the wheel relative to the internal stationary hub; and
a second roller guide coupled to the external stationary hub and configured to roll along the centerless rim.

12. The wheel of claim 11, further comprising an air vent couple coupled to the external stationary hub.

13. The wheel of claim 11, further comprising:
a brake rotor coupled to the centerless rim and configured to rotate with the centerless rim; and
a brake caliper coupled to at least one of the internal stationary hub and the external stationary hub, the brake caliper configured to, when activated, slow rotation of the brake rotor.

14. The wheel of claim 11, further comprising a locking nut physically coupling the internal stationary hub and the external stationary hub.

15. The wheel of claim 11, wherein the internal stationary hub includes a suspension interface configured to couple with a suspension arm of a vehicle.

16. The wheel of claim 15, wherein the suspension interface is configured to interface with multiple suspension arms.

17. The wheel of claim 15, wherein the suspension interface is located within the central region of the centerless rim.

18. The wheel of claim 17, wherein the suspension interface is located proximate a center line of a tire coupled to the centerless rim.

19. The wheel of claim 11, wherein the first roller guide includes an axis of rotation oriented in a different direction from an axis of rotation of the wheel.

20. The wheel of claim 11, further comprising a third roller guide coupled to the internal stationary hub, the third roller guide including an axis of rotation oriented in a different direction from both the axis of rotation of the first roller guide and the axis of rotation of the wheel.
